(19) United States
(12) Patent Application Publication
(10) Pub. No.: US 2006/0231361 A1
(43) Pub. Date: Oct. 19, 2006

(54) Single-cylinder hydraulic shock absorber

(76) Inventor: Shigeru Kojima, Tokyo (JP)

Correspondence Address: RABIN & Berdo, PC, 1101 14TH STREET, NW, SUITE 500, WASHINGTON, DC, 20005, US

(21) Appl. No.: 11/353,082

(22) Filed: Feb. 14, 2006

(30) Foreign Application Priority Data
Feb. 25, 2005 (JP) 2005-50578
Feb. 25, 2005 (JP) 2005-50579

(51) Int. Cl. F16F 9/00

(52) U.S. Cl. 188/322.19

(57) ABSTRACT

A single-cylinder hydraulic shock absorber (1) is provided with an air chamber (2) which is formed by a flexible tubular member (2a) connected air-tightly to each of an upper part of a cylinder (11) and a piston rod (12) to enclose air therein. The air chamber (2a) includes at the lower end a tubular protector (23) engaged to an upper part of the cylinder (11). A flexion part (23a) in an upper end of the protector (23) is retained on an upper end surface of the cylinder (11). A seal member (3) located between the flexion part (23a) and the upper end surface includes a cored bar (33) fixed on the upper end surface of the cylinder (11) and having a dust lip (31) and an oil lip (32), and a circular air seal (5) interposed between the cored bar and the flexion part.

### FIELD OF THE INVENTION

The present invention relates to an improvement of a single-cylinder hydraulic shock absorber with an air spring used in a suspension device for a vehicle.

### BACKGROUND OF THE INVENTION

A single-cylinder hydraulic shock absorber having an air chamber in an upper part thereof is, as shown in Japanese Unexamined Patent Publication JP 2004-332747 A, known as a hydraulic shock absorber used in a suspension device for a vehicle.

In this case, the air chamber is provided with a rolling diaphragm and one end side of the rolling diaphragm is connected air-tightly to a piston rod and the other end side is connected air-tightly to a cylinder side, thus maintaining air-tightness in the air chamber.

### SUMMARY OF THE INVENTION

In a case where the cylinder is formed of an aluminum material, the weight of the hydraulic shock absorber is largely reduced. However, when the rolling diaphragm is jointed air-tightly to the aluminum cylinder by welding, strength of the aluminum material is undesirably reduced.

In view of the above, there exists a need for a single-cylinder hydraulic shock absorber which overcomes the above-mentioned problems in the related art. The present invention addresses these needs in the related art, as well as other needs, which will become apparent to those skilled in the art from this disclosure.

The present invention has an object of providing a hydraulic shock absorber, which can maintain air-tightness in an air chamber without reduction in strength of a cylinder.

In order to achieve above the object an aspect of the present invention provides a single-cylinder hydraulic shock absorber. The shock absorber provides a cylinder, a piston rod slidably moving out from an upper part of the cylinder into an exterior, and a flexible tubular member to form an air chamber connected air-tightly to the upper part of the cylinder and the piston rod respectively and enclosing air therein. The flexible tubular member includes a lower end provided with a tubular protector engaged to the upper part of the cylinder, an inner periphery of an upper end of the protector includes a flexion part bent inside, the flexion part is retained on an upper end surface of the cylinder, a seal member is interposed between the flexion part and the upper end surface of the cylinder, the seal member includes a dust lip and an oil lip contacting on an outer periphery of the piston rod in an inner periphery side, and also a cored bar fixed on the upper end surface of the cylinder by caulking and a circular air seal interposed between the cored bar and the flexion part of the protector, so that the air seal prevents air inside the air chamber from leaking from an engagement clearance between the protector and the cylinder.

Therefore, according to the aspect of the present invention, since an air seal disposed between an upper end surface of a cylinder and a bending part of a protector prevents leakage of air inside the air chamber, the air-tightness in a jointing face between the cylinder and the protector can be properly maintained without welding jointing portions therebetween.

Therefore, when the cylinder is formed of an aluminum material for light weight of the shock absorber, reduction in strength of the cylinder due to welding can be prevented without fail.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a front view of a cross section showing a part of a single-cylinder hydraulic shock absorber in a first preferred embodiment of the present invention;

FIG. 2 is a partial front view of a cross section showing an enlarged key part in FIG. 1;

FIG. 3 is a partial front view of a cross section showing an enlarged key part in a second preferred embodiment of the present invention;

FIG. 4 is a partial front view of a cross section showing an enlarged key part in a third preferred embodiment of the present invention; and

FIG. 5 is a partial front view of a cross section showing an enlarged key part in a fourth preferred embodiment of the present invention.

### DETAILED DESCRIPTION OF THE PREFERRED EMBODIMENTS

Preferred embodiments of the present invention will be explained with reference to the drawings.

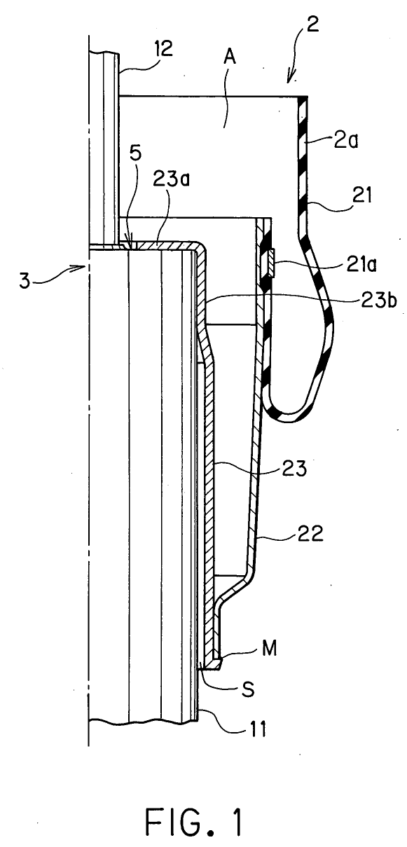

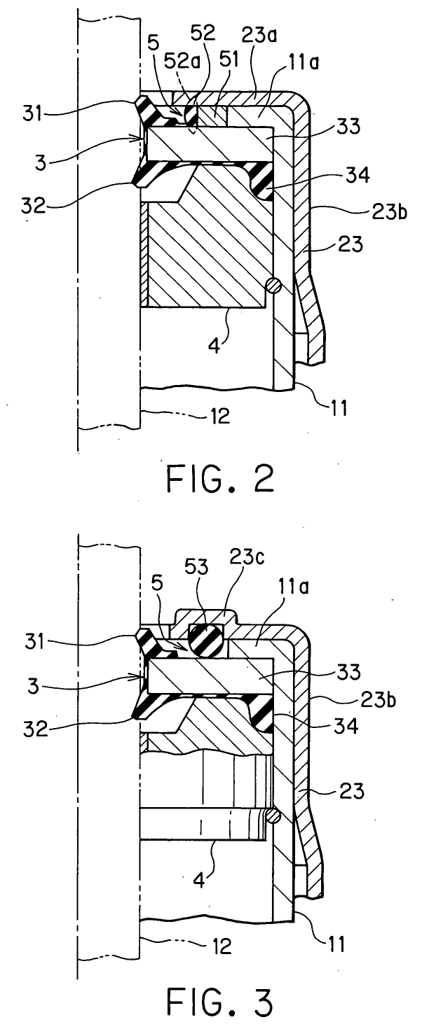

A first preferred embodiment of the present invention shown in FIGS. 1 and 2 will be hereinafter explained.

As shown in FIG. 1, a single-cylinder hydraulic shock absorber 1 of the first preferred embodiment is provided with a cylinder 11 formed of an aluminum material and an air chamber 2 as an air spring disposed in an upper end side of the cylinder 11. However, only a part of the air chamber 2 is shown.

As shown in FIG. 2, an entire periphery of an upper end as an opening end of the cylinder 11 is bent inside by caulking work. An oil seal is fixed to an upper end surface of the cylinder 11 by a caulking end 11a bent inside and an upper end opening of the cylinder 11 is closed with the oil seal 3.

A piston rod 12 penetrates through a center of the oil seal 3. The oil seal 3 sweeps oil which adheres to a surface of the piston rod 12, thus preventing the oil from leaking from an inside of the cylinder 11 to an exterior.

The oil seal 3 is retained in a state of being seated at an upper end of a bearing member 4 through which the piston rod 12 is slidably supported.

As shown in FIG. 1, the air chamber 2 is formed of a flexible tubular member 2a which includes a tubular rolling diaphragm 21 made of a flexible material such as rubber, a piston pipe 22 made of a metallic pipe or the like connected to an inside of a lower end of the rolling diaphragm 21, and a protector 23 made of the same, that is, a metallic pipe or the like connected to an inside of the piston pipe 22.

An upper end part of the protector 23 is jointed air-tightly to the cylinder 11, which will be explained later. An upper end (not shown) of the rolling diaphragm 21 is jointed air-tightly to an outer periphery of an upper part of the piston rod 12, so that a closed space is formed for enclosing a gas inside the rolling diaphragm 21. Expansion or compression of this gas-enclosing space serves as an air spring for exerting spring forces in an expansion direction on the piston rod 12.

In more detail, the rolling diaphragm 21 is formed in a tubular shape having a relatively larger diameter as compared to the piston pipe 22 or the like and is provided with a so-called loosing part formed in such a way as to wind in the lower end part. The other end part turned up in an inside of the rolling diaphragm 21 is engaged to an outer periphery of the upper end part of the piston pipe 22 and clamped air-tightly thereto, for example, by a clamp band 21a.

The rolling diaphragm 21 is to define an air space A closed inside a so-called rubber membrane, which serves as an air spring urging the piston rod 12 toward the expansion direction by pressures of air or another gas enclosed in the air space A.

The piston pipe 22, in many cases, is formed in a tubular shape with the lower part being contracted. An upper end part of the piston pipe 22 is jointed air-tightly to the lower end part of the rolling diaphragm 21, and a lower end part in a reduced diameter of the piston pipe 22 is engaged to an outer periphery of a lower end part of the protector 23 and also jointed air-tightly thereto.

The protector 23 has a smaller diameter as compared to that of the piston pipe 22, but is formed in a tubular shape having a slightly larger diameter than that of the cylinder 11 and covers an upper part of the cylinder 11 from an outer side thereof. An upper end of the protector 23 constitutes a flexion part 23a bent inside and is engaged to the upper end surface of the cylinder 11 by the flexion part 23a.

The protector 23 and piston pipe 22 both are made of the same metal material and the respective connecting portions are air-tightly jointed by welding (welding portion is indicated by code M).

It should be noted that the protector 23 may be formed of an aluminum material. In this case, the lower end part of the piston pipe 22 and the lower end part of the protector 23 are not jointed by welding, but for example (not shown), in a state where a seal material is located therebetween, the outer periphery of the lower end of the protector 23 is press-fitted into the lower end part of the piston pipe 22, thus providing a predetermined air-tight structure therebetween.

A case where the protector 23 is formed of an aluminum material, with the cylinder made of an aluminum material, contributes to weight reduction of the air chamber 2 having the protector 23, thus enabling further reduction of the entire weight of a single-cylinder hydraulic shock-absorber with an air spring.

The protector 23 has the upper part, which is a diameter-reduced part 23b associated with the flexion part 23a and an inner diameter of the diameter-reduced part 23b corresponds substantially to an outer diameter of the cylinder 11. Until the flexion part 23a in the upper end of the protector 23 gets in contact with the caulking end 11a of the upper end in the cylinder 11, the diameter-reduced part 23b of the protector 23 is forced to move to be engaged to the cylinder 11 for fixation. At this point, the lower end side of the protector 23 is formed so as to have a predetermined clearance to the outer periphery of the cylinder 11. This provides a clearance (S) formed between the protection 23 and the cylinder 11 to communicate with an atmosphere, and heat from the cylinder 11 is released via this clearance (S) to an exterior.

The flexion part 23a is formed in a flange shape by bending the upper end part of the protector 23 inside. This method makes it easier to manufacture components, as compared to a method that the flange part, that is, the flexion part 23a is formed of a different component, which is then connected to the upper end of the protector 23 by welding and also has an advantage that mechanical strength is easier to guarantee.

The reason for forming the flexion part 23a in a flange shape is that it is easier to realize the structure for blocking passing of air between the flexion part 23a and a sub seal 5 to be described later.

Next, the oil seal 3, as shown in FIG. 2, includes integrally a dust strip 31 and an oil lip 32, each having an inner surface sliding and contacting with an outer periphery of the piston rod 12, disposed in an inner periphery side of a circular, cored bar 33 and also an outer periphery lip 34 retained integrally in an outer periphery side of the cored bar 33 to maintain a liquid-tight state with an inner periphery of the cylinder 11. An outer periphery portion of the cored bar 33 is placed between the caulking end 11a of the cylinder 11 and the bearing member 4 and is fixed therein by caulking.

Since the oil seal 3 is formed as described above, at the time the piston rod 12 enters into the cylinder 11, dusts which have adhered to the outer periphery of the piston rod 12 are swept off with the dust lip 31, and at the time the piston rod 12 moves out from the cylinder 11, oil which has adhered to the outer periphery of the piston rod 12 is swept with the oil lip 32.

In the oil seal 3, air between the caulking end 11a of the cylinder 11 and the cored bar 33, since the outer periphery lip 34 has liquid-tight properties as described above, is prevented from leaking into the cylinder 11 by the outer periphery lip 34.

The sub seal 5 is formed in a circular shape and is, as shown in FIG. 2, located between the cored bar 33 of the oil seal 3 and the flexion part 23a of the protector 23, thus blocking leak of air between the flexion part 23a and the caulking end 11a of the cylinder 11, and between the cored bar 33 of the oil seal 3 and the caulking end 11a of the cylinder 11.

However, in regard to the passing of air between the cored bar 33 of the oil seal 3 and the caulking end 11a of the cylinder 11, since the outer periphery lip 34 of the oil seal 3 resultantly blocks leakage of air into the cylinder 11, it is not necessary to absolutely block passing of air between the cored bar 33 of the oil seal 3 and the caulking end 11a of the cylinder 11.

Judging from this, in regard to the above-mentioned sub seal 5, any construction may be selected as long as the function for preventing leak of air between the flexion part 23a of the protector 23 and the caulking end 11a of the cylinder 11 is assured.

Therefore, the sub seal 5 shown in FIG. 2 includes a circular metal 51 retained between the cored bar 33 of the oil seal 3 and the flexion part 23a of the protector 23 and a circular air seal 52 adjacent to an inner periphery of the metal 51. The air seal 52 is retained integrally with the inner periphery of the metal 51. It should be noted that the metal 51 is formed in thickness the same as the cored bar 33.

At this point, the air seal 52 is designed to be pressed and deformed by the flexion part 23a of the protector 23 and therefore is forced to be closely in contact with the flexion part 23a and the cored bar 33 of the oil seal 3. As a result, the air seal 52 is to block air leakage between the flexion part 23a and the air seal 52 and between the cored bar 33 and air seal 52, that is, prevents air from the air space A inside the air chamber 2 from flowing out into an exterior through a clearance between the flexion part 23a and the caulking end 11a.

However, the air seal 52 before pressed and deformed is so constructed that both lip ends 52a thereof extend upward and downward as shown in a dotted line in the figure.

As seen from the above description, any shape of the sub seal 5 may be adopted as long as the sub seal 5 performs a predetermined function. For example, in a second preferred embodiment shown in FIG. 3, the sub seal 5 is formed of an O-ring 53.

In a case where the sub seal 5 is the O-ring 53, the O-ring 53 is received in a circular groove part 23c formed to be oriented downward in the flexion part 23a of the protector 23.

Even in the sub seal 5 formed of the O-ring 53, naturally the sub seal 5 is pressed and deformed when it is retained in the circular groove part 23c between the cored bar 33 of the oil seal 3 and the flexion part 23a of the protector 23.

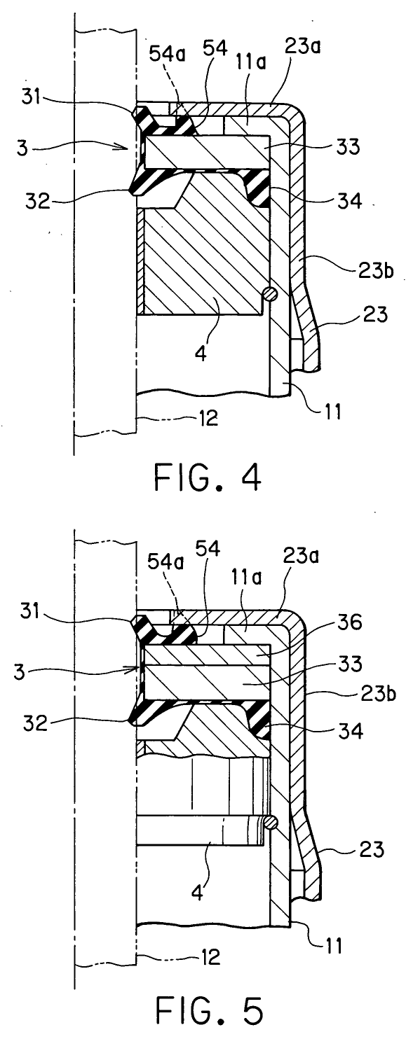

Next, FIG. 4 shows a third preferred embodiment where the sub seal 5 is formed integrally with the oil seal 3.

The oil seal 3 includes integrally a dust strip 31 and an oil lip 32, each having an inner surface sliding and contacting with an outer periphery of the piston rod 12, disposed in an inner periphery side of a circular, cored bar 33 and also an air lip 54 located in an outside of the dust lip 31 in such a way as to surround it and retained integrally with the coed bar 33. The oil seal 3 includes an outer periphery lip 34 retained integrally in an outer periphery side of the cored bar 33 to maintain a liquid-tight state with an inner periphery of the cylinder 11.

The air lip 54 is pressed and deformed by the flexion part 23a of the protector 23 and therefore is forced to be closely in contact with the flexion part 23a and the cored bar 33 of the oil seal 3. As a result, the air lip 54 is to block air leakage between the flexion part 23a and the air lip 54.

However, before the flexion part 23a presses and deforms the air lip 54, a so-called lip end 54a stands upward as shown in a dotted line in the figure.

Further, FIG. 5 shows a fourth preferred embodiment. The cored bar in the oil seal 3 is divided into two layers made of an upper layer and a lower layer, that is, an upper cored bar 36 and a lower cored bar 33, and the air lip 54 is retained in the upper cored bar 36.

the air lip 54, as well as the dust lip 31 are integrally retained in the upper cored bar 36, and the oil lip 32 and the outer periphery lip 34 are integrally retained in the lower cored bar 33. The upper cored bar 36 retains the air lip 54 and the dust lip 31 and the lower cored bar 33 retains the oil lip 32 and the outer periphery lip 34 individually and therefore, the component manufacturing is easier, as compared to a case where all lips, that is, the dust lip 31, the oil lip 32, the outer periphery lip 34, further and the air lip 54 are integrally retained in the single cored bar 33.

In particular, in a case of setting the air lip 54 in various shapes, the cored bar 36 having the air lip 54 formed of a different construction and the cored bar 33 can be combined, that is, any combination of components can be realized.

From the above, in a case where the cored bar is divided into two layers formed of an upper layer and a lower layer, only the air lip 54 is disposed in the upper cored bar 36 (not shown) and the upper end part of the cylinder 11 is processed by caulking so that the cored bar 36 having only the air lip 54 is overlapped over the existing cored bar 33, thereby making it possible to preferably prevent from air leakage.

In a case where the cored bar 36 having only the air lip 54 is overlapped over the existing cored bar 33, it is necessary to pay attention to a shape of the cored bar 36 such that a side end of the inner periphery of the cored bar 36 does not interfere with the dust lip 31 retained in the cored bar 33.

As described above, in a single-cylinder hydraulic shock absorber 1 according to the present invention, the protector 23 is not jointed to the cylinder 11 by welding. Accordingly, even if the protector 23 and the cylinder 11 both are formed of an aluminum material, the strength thereof is not reduced and reduction in weight thereof is possible. Also since the hydraulic shock absorber is formed of a single cylinder, when it is applied to a suspension device for a vehicle, the suspension device is sized to be smaller.

A dumping function generated when the piston rod 12 expands/contracts relative to the cylinder 11 improves depending on high-pressure air or gas enclosed in the air chamber 2, as compared to a plural-cylinder shock absorber enclosing an atmospheric pressure therein. In this case, at an expansion operation of the piston rod 12, in the air chamber 2 the air space A defined by the rolling diaphragm 21 varies in volume corresponding to a changing rod volume of the piston rod 12 entering into or moving out of the cylinder 11. At this point, a predetermined air spring effect is achieved due to inflation/contraction of the rolling diaphragm 21 corresponding to the volume variation.

Since leakage of air from the air chamber as air spring from an engagement portion between the protector 23 and the cylinder 11 is blocked by the sub seal 5 or the air seal 54 in the shock absorber 1, air-tightness in the air chamber 2 is secured permanently, thus-maintaining excellent air spring effect all the time.

This application claims priority to Japanese Patent Applications No. 2005-050578 and 2005-050579. The entire disclosure of Japanese Patent Applications No. 2005-050578 and 2005-050579 are hereby incorporated herein by reference.

While only selected preferred embodiments have been chosen to illustrate the present invention, it will be apparent to those skilled in the art from this disclosure that various changes and modifications can be made herein without departing from the scope of the invention as defined in the appended claims. Furthermore, the foregoing description of the preferred embodiments according to the present invention is provided for illustration only, and not for the purpose of limiting the invention as defined by the appended claims and their equivalents.

What is claimed is:

1. A single-cylinder hydraulic shock absorber, comprising:
a cylinder;
a piston rod slidably moving out from an upper part of the cylinder into an exterior; and
a flexible tubular member to form an air chamber connected air-tightly to the upper part of the cylinder and the piston rod respectively-and enclosing air therein, wherein:
the flexible tubular member includes a lower end provided with a tubular protector engaged to the upper part of the cylinder;
an inner periphery of an upper end of the protector includes a flexion part bent inside;
the flexion part is retained on an upper end surface of the cylinder;
a seal member is interposed between the flexion part and the upper end surface of the cylinder;
the seal member includes a dust lip and an oil lip contacting on an outer periphery of the piston rod in an inner periphery side, and also a cored bar fixed on the upper end surface of the cylinder by caulking and a circular air seal interposed between the cored bar and the flexion part of the protector, so that the air seal prevents air inside the air chamber from leaking from an engagement clearance between the protector and the cylinder.

2. The single-cylinder hydraulic shock absorber according to claim 1, wherein:
an outer periphery part of the cored bar in the seal member is fixed to the upper end surface of the cylinder by a caulking end formed by bending an upper end of the cylinder in an inner periphery side.

3. The single-cylinder hydraulic shock absorber according to claim 2, wherein:
the air seal includes a circular seal located in an inner periphery of a circular metal retained between the cored bar and the flexion part of the protector.

4. The single-cylinder hydraulic shock absorber according to claim 2, wherein:
the air seal includes an O-ring retained between the cored bar and the flexion part of the protector.

5. The single-cylinder hydraulic shock absorber according to claim 2, wherein:
the air seal includes an air lip retained in the cored bar.

6. The single-cylinder hydraulic shock absorber according to claim 5, wherein:
the air lip is formed integrally with the dust lip and is retained in the cored bar.

7. The single-cylinder hydraulic shock absorber according to claim 5, wherein:
the cored bar is divided into two layers as an upper layer and a lower layer; and
the air lip is retained on an upper surface of the cored bar in the upper layer.

8. The single-cylinder hydraulic shock absorber according to claim 7, wherein:
the dust lip and the oil lip are retained in an inner periphery side of the cored bar in the lower layer.

9. The single-cylinder hydraulic shock absorber according to claim 2, wherein:
the seal member includes an outer periphery lip disposed in an outer periphery side of the cored bar to maintain a liquid-tight state with an inner periphery of the cylinder.

10. The single-cylinder hydraulic shock absorber according to claim 1, wherein:
the flexible tubular member includes a rolling diaphragm made of a tubular rubber membrane;
an upper periphery end of the rolling diaphragm is jointed air-tightly to an outer periphery of the piston rod;
one end of a tubular piston pipe is jointed air-tightly to a lower periphery end of the rolling diaphragm; and
the other end of the piston pipe is jointed air-tightly to one end of the protector.
